(19) United States
(12) Patent Application Publication
(10) Pub. No.: US 2008/0269989 A1
(43) Pub. Date: Oct. 30, 2008

(54) Power-assisted steering system

(76) Inventors: Peter Brenner, Moegglingen (DE); Eberhard Kuebler, Stuttgart (DE)

Correspondence Address: JORDAN AND HAMBURG LLP, 122 EAST 42ND STREET, SUITE 4000, NEW YORK, NY, 10168, US

(21) Appl. No.: 12/080,861

(22) Filed: Apr. 7, 2008

(30) Foreign Application Priority Data
Apr. 26, 2007 (DE) 10 2007 019 724.3

(51) Int. Cl. B62D 5/04

(52) U.S. Cl. 701/42

(57) ABSTRACT

A power-assisted steering system, a control device, and a method for operating this power-assisted steering system in accordance with which a control device is supplemented with at least one function for driver assistance during off-road operation based upon an operating characteristic.

### BACKGROUND OF THE INVENTION

The invention relates to a power-assisted steering system, a control device for a power-assisted steering system, and a method for operating said power-assisted steering system.

The performance of electrically assisted power steering systems becomes increasingly complex as the systems transition from sub-compact, compact, and mid-size vehicles to full size vehicles. Especially with off-road vehicles and so-called SUVs (SUV: Sports Utility Vehicle), these functions can be advantageous because, with appropriate applications of the steering functions such as, for example, speed-related steering assistance, speed-related steering damping, and speed-related active steering, they can compensate for, at least in part, design-related disadvantages that result from the tendency to roll, which is normally associated with these vehicles due to their high center of gravity, and from their relative instability at high vehicle speeds on roads.

Especially when operating these vehicles off-road, there are additional idiosyncrasies that confront, in particular, inexperienced drivers with situations that can lead to incorrect reactions and therefore possibly to accidents during off-road operation.

### SUMMARY OF THE INVENTION

The power-assisted steering system for a motor vehicle according to the invention has a servo drive with an electric motor and an electronic control device for controlling the electric motor. In accordance with this power-assisted steering system, the control device is supplemented with at least one function for driver assistance during off-road operation so that by utilizing this at least one function, one characteristic of a steering torque assistance that results from actuating the electronic control device will be influenced.

Thus, it is suggested that the potential functionality of the electrical power steering be supplemented with functions for driver assistance during off-road operation. Comfort, and above all safety, can be significantly enhanced using the possibly freely-programmable assistance and the creation of an active assistance torque. The driver is provided with assistance recommendations, for instance, by adjusting or changing the characteristic line for the steering torque assistance. Normally the driver is not dominated by the power-assisted steering system.

Adjusting the torque characteristic can lead to the steering becoming lighter or heavier. Moreover, it should be noted that the electric motor used must provide the relatively high steering rack forces.

The inventive electronic control device is provided for employment in a power-assisted steering system of a motor vehicle and actuates an electric motor of a servo drive. The control device is supplemented with at least one function for driver assistance during off-road operation so that, depending on this at least one function, one characteristic of a steering torque assistance that occurs due to actuating the electronic control device will be influenced. The method according to the invention is used for operating a power-assisted steering system having a servo drive with an electric motor and an electronic control device for actuating the electric motor. In accordance with the invention, it is provided that the control device is supplemented with at least one function for driver assistance during off-road operation so that, depending on this at least one function one characteristic of a steering torque, assistance is influenced.

A computer program according to the invention includes program coding means for performing a method for operating a power-assisted steering system as is described in the foregoing when the computer program is executed on a microprocessor of a computer, in particular, in a control device of the power-assisted steering system.

This computer program can be stored on a computer-readable data carrier such as, for example, a diskette, CD, DVD, hard drive, USB memory stick, or the like, or on an internet server as a computer program product. From there, the computer program can be transferred to a memory element of the control device and then can be executed.

Functions with which the control device is supplemented in the aforesaid power-assisted steering system and in the aforesaid method are discussed below.

In many SUVs and off-road vehicles there is the option for shifting to an additional gear stage in order to increase the climbing ability and maneuverability of the vehicle. It is suggested to change the characteristic of the steering torque assistance as a function of this gear position with the goal of optimizing the steering feedback to the driver, in particular during off-road operation.

This means that in one embodiment, the power-assisted steering changes the characteristic of the steering torque assistance as a function of the gear position.

In the class of vehicles in question, in many cases the function of the longitudinal or transverse differential can be influenced either by manual intervention by the driver or by electronically controlled intervention by a slip-control system. It is suggested to change the steering characteristic based on this information in order to correct the modified driving behavior and thus the modified steering feedback and also to reinforce them in order to enhance comfort and safety. Thus in this embodiment the power-assisted steering system modifies the characteristic of the steering torque assistance as a function of the settings for the longitudinal differential and/or the transverse differential.

During operations in steep terrain there is always the risk that the vehicle will roll when, for example, the driver introduces a steering angle that is too large during steep travel and thus changes direction in a manner that is dangerous. It is suggested to use information from the vehicle, such as, for example, the drive torque or drag torque of the motor vehicle, the output signals from the sensor element and/or from function modules for other control devices for detecting longitudinal and transverse inclination, interventions by the slip-control system, etc., in such a form that critical or potentially dangerous situations are detected and this information is provided to the driver by appropriately influencing the steering torque on the steering wheel. Thus, the situation is not further aggravated and the driver can change his behavior to return to a stable and non-hazardous situation. It can thus be provided that the power-assisted steering system changes the characteristic of the steering torque assistance depending on signals that, for example, provide information on the inclination of the vehicle and/or interventions by the slip-control systems.

Because it is possible to measure and evaluate the manual torque of the driver and the assistance applied by the steering system in the electric power steering system, loads that in some circumstances can cause damage to the undercarriage, wheels, and steering system of the vehicle can be detected and the driver can be informed using corresponding steering torque assistance. In addition, these detected operating conditions can be reported to the installed and networked partner systems such as, for example, the slip-control system, damping control, motor management, etc., in order to initiate appropriate measures, if necessary. It can therefore be provided that information on manual torque of the driver or on manual torque progression and assistance provided by the servo drive is provided for diagnostic purposes.

The functions described can be realized individually, together, or in desired combinations. In particular these functions and their effect on the steering torque assistance can be programmed freely by the driver or can be supplied at the factory.

Additional advantages and embodiments of the invention result from the description and the attached drawing.

It is understood that the aforesaid features and the features to be explained in the following can be used not only in the combination described, but also in other combinations or alone without departing from the framework of the invention.

The invention is depicted schematically in the drawing using one exemplary embodiment and is described in detail in the following, with reference to the drawing.

### BRIEF DESCRIPTION OF THE DRAWING

FIG. 1 depicts one embodiment of the inventive power-assisted steering system.

### DETAILED DESCRIPTION OF THE INVENTION

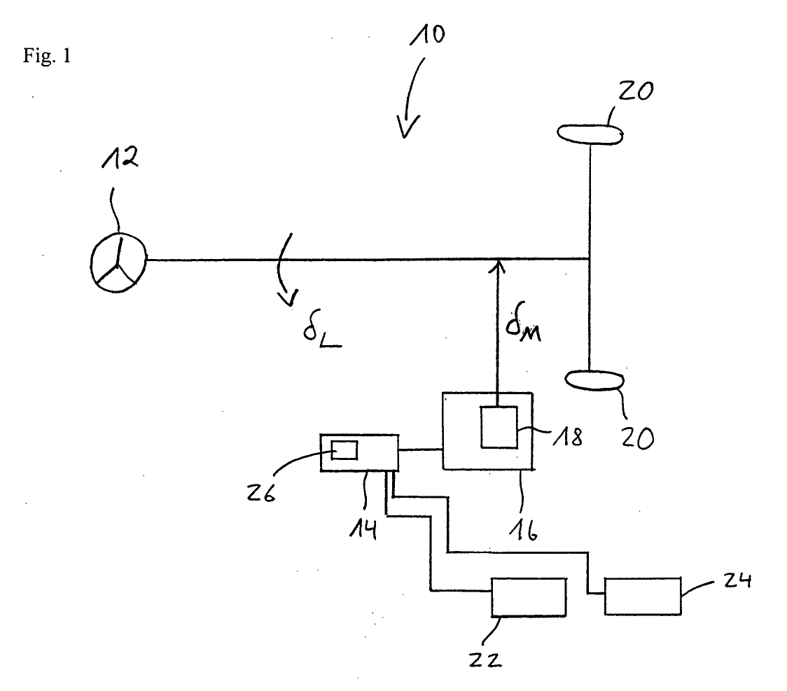

The schematic depiction in FIG. 1 illustrates one possible embodiment of the inventive power-assisted steering system, which is labeled in general with reference number 10.

The depicted power-assisted steering system 10 has a steering handle 12 embodied as a steering wheel, an electrical control device 14, and a servo drive 16 with a motor 18. The wheels 20 of a motor vehicle are steered therewith.

In addition to a steering angle δ_{L} provided with the steering handle 12, a motor angle δ_{M} applied in the servo drive 16 by the motor 18 is transmitted to the wheels 20 for assisting the driver. The servo drive 16 is actuated by the control device 14 for this.

In addition, a first sensor 22 and a second sensor 24 are provided. The first sensor detects the position of the transmission of the vehicle. For instance, if it is detected that the driver has selected a gear stage provided especially for off-road operation, a corresponding signal is provided to the control device 14, whereupon the characteristic of the steering torque assistance is adjusted.

The second sensor 24 detects the inclination of the vehicle. If a critical situation is detected, a corresponding signal is forwarded to the control device 14. The driver is then warned using appropriate influence on the steering torque.

Also provided in the control device 14 is a memory unit 26 in which are stored the progression of the manual torque of the driver and the steering assistance applied. This information can be read out for diagnostic purposes. When needed, this information can be forwarded to networked partner systems and where necessary appropriate measures can also be initiated directly.

1.-12. (canceled)

13. A power-assisted steering system for a motor vehicle, comprising:
a servo drive including an electric motor, said servo drive being operable for transmitting steering torque assistance to steered wheels of the motor vehicle; and
an electronic control device for controlling said electric motor, said control device being configured to influence said steering torque assistance as at least one function of at least one vehicle off-road operational characteristic.

14. A power-assisted steering system according to claim 13, wherein said at least one function includes a function of gear position.

15. A power-assisted steering system according to claim 13, wherein said at least one function includes a function of settings of a longitudinal differential and/or transverse differentials gear position.

16. A power-assisted steering system according to claim 15, wherein the settings of the longitudinal differential and/or the transverse differentials are specified via manual intervention by a driver.

17. A power-assisted steering system according to claim 15, wherein the settings of the longitudinal differential and/or the transverse differentials are specified via an electronically controlled intervention by a slip-control system.

18. A power-assisted steering system according to claim 13, wherein said at least one function includes a function of signals that carry information on an inclination of the vehicle.

19. A power-assisted steering system according to claim 13, wherein said at least one function includes a function of signals that carry information on interventions by slip-control systems.

20. A power-assisted steering system according to claim 13, wherein information on manual torque of the driver and on assistance applied by the servo drive is used for diagnostic purposes.

21. An electronic control device for a power-assisted steering system for a motor vehicle for controlling an electric motor, comprising:
a first configuration operable to receive data representative of at least one vehicle off-road operational characteristic; and
a second configuration operable to influence said steering torque assistance as at least one function of the at least one vehicle off-road operational characteristic.

22. A method for operating a power-assisted steering system, comprising:
ascertaining at least one vehicle off-road characteristic; and
controlling an electric motor which transmits steering torque assistance to steered wheels of a motor vehicle as at least one function of said at least one vehicle off-road operational characteristic.

23. A method according to claim 22, wherein said controlling is implemented by a control device of a power-assisted steering system.

24. A computer readable storage medium for storing a program executable by a processing device for performing at least one action comprising;
ascertaining at least one vehicle off-road characteristic; and
controlling an electric motor which transmits steering torque assistance to steered wheels of a motor vehicle as at least one function of said at least one vehicle off-road operational characteristic.

25. A computer readable storage medium according to claim 24, wherein said controlling is implemented by a control device of a power-assisted steering system.
